(19) United States
(12) Patent Application Publication
(10) Pub. No.: US 2012/0289226 A1
(43) Pub. Date: Nov. 15, 2012

(54) CELLULAR ACCESS POINT FOR SEARCH AND RESCUE

(76) Inventor: David Allen Burgess, Fairfield, CA (US)

(21) Appl. No.: 13/103,836

(22) Filed: May 9, 2011

(51) Int. Cl. H04W 4/00

(52) U.S. Cl. 455/434

(57) ABSTRACT

The cellular access point for search and rescue is a cellular basestation and associated control computer providing functions for the location of cellular handsets in collapsed structures and to provide a means for rescue team members to communicate with trapped accident victims.

### FIELD OF THE INVENTION

The present invention is in the field of specialized equipment for search and rescue operations, specifically equipment to facilitate communication with disaster victims to locate disaster victims.

### BACKGROUND OF THE INVENTION

Sometimes in the aftermath of a disaster, rescue workers are faced with the problem of locating disaster victims under collapsed buildings or in other types of debris fields. Many of these disaster victims are likely to be carrying cellular telephones. The present invention aids rescue workers in locating cellular telephones in the likelihood that this will also locate the individuals who where carrying them.

### SUMMARY OF THE INVENTION

The object of this invention is to provide a method for locating and communicating with victims of accidents and large-scale disasters, including people trapped in collapsed buildings or other wreckage.

In part, the invention describes a device (a “rescue access point”) that mimics the function of a cellular network, presenting handsets with a normal looking cellular signal. Handsets respond to this signal by registering with the rescue access point as if it were a normal cellular network. Once a handset is registered, the rescue access point can initiate transactions with the handset, including text messages, telephone calls and non-standard transactions that can reveal the handset's location. The invention can also be used to make measurements of the handset radio signal that can aid in locating a handset.

### DESCRIPTION OF PRIOR ART

U.S. Pat. No. 34,035,913———Impson, et al (2010)

U.S. Pat. No. 34,035,913 “Rapidly deployable emergency communications system and method”, and several of the patents it references, describe rapidly-deployable communications systems. However, these systems are intended for communication among rescuers, not between rescuers and victims. Similarly, many of these systems include features for determining and tracking the locations of rescuers, but not for locating victims. The key difference in functionality between serving rescuers and serving vict

### BRIEF DESCRIPTION OF THE DRAWINGS

FIG. 1 shows the rescue cellular access point comprising:

ordinary cellular telephone handsets (1) carried by a rescue team member or on the person of a disaster victim,

a “network in a box” cellular basestation (2), which includes both the radio access network (RAN) and radio network control (RNC) functions of a cellular network,

the “radio interface” (3) through which the handsets communicate with the basestation,

a “handset database” (5) which contains the identities of handsets carried be the rescue team

a “user interface” (4) through which the operator interacts with the rescue BTS and

the human operator (6) of the rescue BTS.

FIG. 2 shows the installation of a rescue cellular access point in a tunnel, mine or other underground facility comprising:

the rescue cellular access point (10),

a section of radio frequency (RF) coaxial cable or fiber optic cable (12),

a bidirectional RF repeater (11),

a “leaky-coax” type antenna running the length of an underground passage (13) and

a cellular telephone handset (14).

### DETAILED DESCRIPTION OF THE DRAWINGS

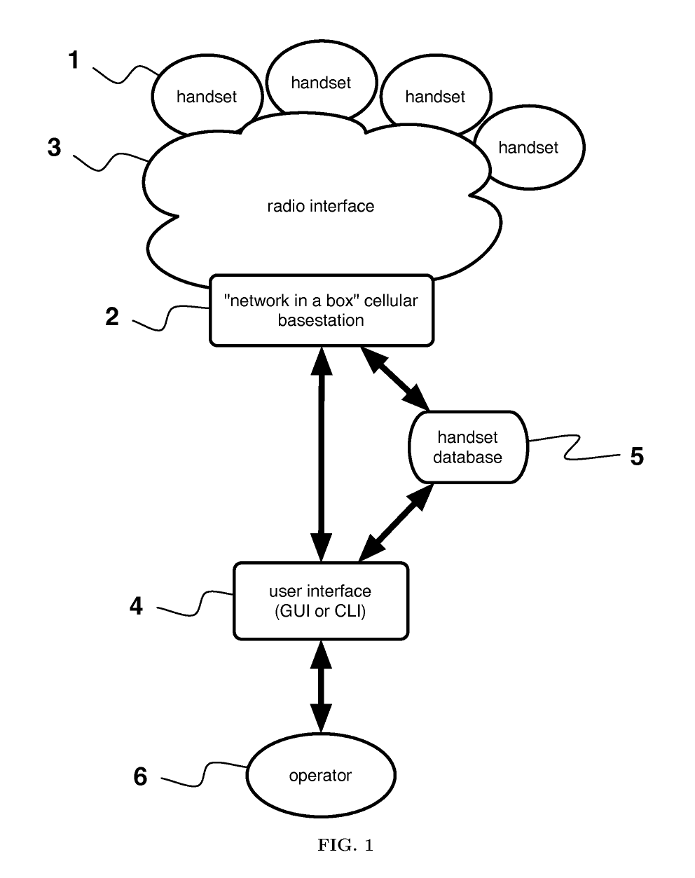

FIG. 1 shows the components of the rescue cellular access point.

The handsets (1) are ordinary cellular telephone handsets. These headsets may be carried by a rescue team members. The handsets may also be on or near the persons of the disaster or accident victims, having been carried by the victims routinely just prior to the destructive event.

The “network in a box” cellular basestation (2) provides the functions of the radio access network (RAN) and radio network control (RNC) found in a complete cellular network. The basestation presents a standard cellular “radio interface” (3) which the handsets recognize as a cellular network from which they might receive service.

The “handset database” (5) contains the identities of handsets carried be the rescue team. This information is used to distinguish members of the rescue team from the people they have come to rescue.

The “user interface” (4) in the interface through which the human operator (5) interacts with the rescue BTS. This interface might be a graphical user interface (GUI) or a text-based command line interface (CLI). This interface provides control over the functions of the rescue access point, including but not limited to

delivery of text messages to specific handsets,

delivery of text messages to groups of handsets,

placement of telephone calls to handsets

location requests to GPS receivers manufactured into the handsets and

control of handset transmitters as trackable beacons.

This interface also provides the operator with information about the operation of the access point and its interaction with handsets in the area, including but not limited to

population counts of rescuer and non-rescuer handsets in the area of operation,

location data recovered from GPS receivers present in handsets,

transmitted and received power levels associated with specific handsets,

estimated distance to the handset and

call activity among handsets.

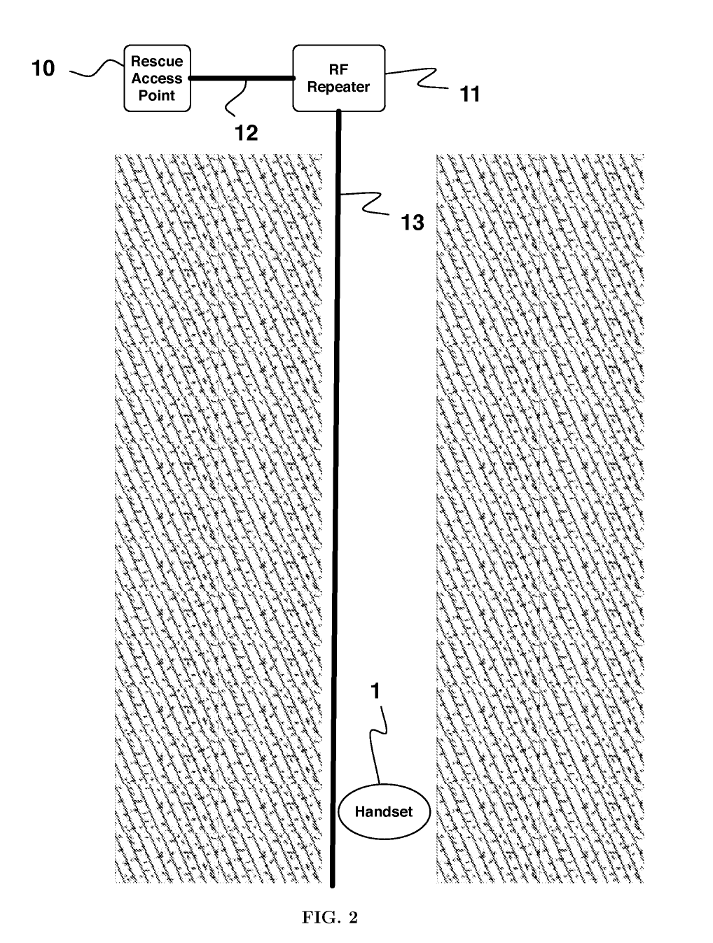

FIG. 2 shows the rescue cellular access point installed in an underground facility such as a tunnel or mineshaft. The rescue cellular access point itself (10) is often not installed directly in the underground facility. For example, mine safety runs may allow only a very limited set of pre-approved equipment to be installed underground, requiring that the rescue access point operate through a bidirectional repeater (11), connected through a coaxial or fiber optic cable (12). A “leaky-coax” antenna (13) carries the cellular signal deep in to the facility. This leaky-coax antenna is a section of coaxial cable that has has its shielding deliberately compromised to allow radio signals to “leak” in and out, affording cellular service to handsets (1) that are within a few meters of the leaky-coax antenna. In this arrangement, the estimated radio propagation delays along the leaky-coax antenna can be used to estimate the distance of the handset along the tunnel. In FIG. 2, the tunnel is shown as straight for simplicity, but this need not be the case and the resulting distance estimates are useful for determining the location of the handset regardless of the shape of the tunnel.

### Initial Practical Embodiment

The rescue access point (“AP”) presents standard network-side cellular radio interface to handsets in the rescue area, using a radio channel frequency and a set of identity parameters chosen to induce handsets to register to it. For example, the AP would operate in a frequency band commonly used for cellular service in the deployment area, advertising the network identity parameters of a cellular carrier that normally operate in the deployment area.

While the radio interface presented by the AP is the same as a conventional cellular network, the AP need not be connected to the infrastructure of a conventional cellular network. Instead, the AP terminates all signaling protocols locally so that it can connect telephone calls and deliver text messages in the local service area without the support of any external services. The common industry term for this local functionality is “network in a box”.

When handsets attempt to get service from the AP, they will reveal or be induced to reveal a unique identifier, either an IMSI (International Subscriber Mobile Identity) or IMEI (International Mobile Equipment Identity), depending on the cellular technology used. The AP records these identities in a local database as they are revealed. This database also contains the identifiers (IMSIs or IMEIs) of handsets carried by the rescue team (“known handsets”). Known handsets are tagged in the database so that they can be distinguished from other handsets (“unknown handsets”) and processed differently. The controls of a user interface, the operator can also use the local database to selectively deny registration to known handsets so that they will remain in the service of a normal cellular carrier.

An important feature of most cellular interfaces is that they require precise synchronization of the radio signals between the handset and the serving network. To achieve this synchronization, the handset and network make frequent estimates of propagation delay between them. This propagation delay is proportional to the distance between the handset and the network basestation serving that handset. It is well known that the distance from the serving basestation to the handset can be estimated from these propagation delay estimates.

Once a handset is registered into the cellular coverage of the AP, the operator can use a user interface to control the AP to perform any of several transactions with a specific handset or with any selected group of handset:

The AP can be used to send a text message to a handset. The message may contain specific instructions for disaster victims and can be used to elicit an audible ringtone from a handset, aiding in handset location. Because the AP addresses the handset by IMSI or IMEI, knowledge of the handset telephone number is not required for this operation.

The AP can be used to intercept outgoing phone calls and text messages from handsets, diverting these communications to a public service answering point (PSAP) or directly to the local rescue team.

The AP can be used to place telephone calls to handsets, either to communicate with disaster victims or to elicit an audible ringtone from the handset, aiding in handset location. Because the AP addresses the handset by IMSI or IMEI, knowledge of the handset telephone number is not required for this operation.

The rescue access point can be used to force a handset into a transmitting mode by directing the handset to a radio channel as if it is about to receive an incoming call, but without actually delivering such a call. The handset will then wait on the radio channel, transmitting an idle pattern until the AP directs the handset to abandon the radio channel. Once in this transmitting mode, the handset can be located using conventional radiolocation products and techniques.

The AP can use the timing of received signals from a handset to estimate distance to that handset. If two or more instances of the invention are used together, the multiple distance estimates can be used to estimate the location of a given handset.

The AP can use the relationship between the estimated distance to a handset and the received power level from that handset to determine how deeply that handset might be buried under a debris field.

The operator of the AP controls these functions through a graphical user interface (GUI) or command line interface (CLI), selecting groups of handset identities from the local database. The operator does not need knowledge of the handset's normal telephone number to perform any of the actions listed above.

Unlike a normal cellular basestation, the AP will be typically be operated with a narrow beam antenna on a portable mast. The purpose of the narrow beam antenna is to confine the coverage area of the access point signal, to a specific collapsed building, for example.

### Enhancements

The rescue access point can be pre-installed in underground facilities such as mine shafts or transportation tunnels, either directly installed or connected to the underground facility through a radio frequency or optical repeater. In such installations, the rescue access point would use a “leaky coax” antenna running the length of the tunnel or shaft, protected by a dielectric conduit to prevent damage in the event of a collapse. In such installations, the rescue BTS might also be used to provide routine wireless telephone or intercom service inside the facility. This arrangement is shown in FIG. 2. In this configuration, the radio propagation delay along the leaky-coax antenna can be used to determine the distance along a tunnel or mine shaft from the rescue cellular access point to the transmitting handset.

The rescue access point can be connected a voice-over-internet (VoIP) service provider through a satellite link or long-distance point-to-point radio link. The VoIP carrier can provide origination and termination services in the public switched telephone network (PSTN) to allow rescue team members to place and receive ordinary telephone calls through the system.

### Benefits of the Invention

The primary benefit of the rescue cellular access point is to improve the communication and situational awareness of a rescue with respect to the people they are trying to rescue. This is different from most developments in this field, which by and large are intended to improve communication and situational awareness of the rescue team members with respect to each other. The rescue cellular access point also provides a novel method for locating disaster victims in debris fields and collapsed structures, saving lives and reducing suffering by improving the efficiency of rescue operations in the aftermath of an earthquake, mine collapse or other disaster in which people are buried alive.

### Other Embodiments

Variations or modifications to the design and construction of this invention, within the scope of the appended claims, may occur to those skilled in the art upon reviewing the disclosure herein (especially to those using computer aided design systems). Such variations or modifications, if within the spirit of this invention, are intended to be encompassed within the scope of any claims to patent protection issuing upon this invention.

### CROSS REFERENCE TO DISCLOSURE DOCUMENT

This application is based upon provisional patent application “Utility Patent Application (Provisional) Cellular Access Point for Search and Rescue” filed 10 May 2010.

The embodiments of the invention in which we claim an exclusive property or privilege are defined as follows:

1. A rescue cellular access point, comprising: a self-contained cellular network with autonomous air interface and network control functions, a database of handset identities and a user interface, graphical or text-based, controlling that self-contained cellular network to perform a set of functions including handset identity interrogation.

2. A rescue cellular access point, comprising: a self-contained cellular network with autonomous air interface and network control functions, a database of handset identities and a user interface, graphical or text-based, controlling that self-contained cellular network to perform a set of functions including text message delivery to handsets without knowledge of assigned telephone numbers, either to specific individual handsets or to groups of handset in the service area.

3. A rescue cellular access point, comprising: a self-contained cellular network with autonomous air interface and network control functions, a database of handset identities and a user interface, graphical or text-based, controlling that self-contained cellular network to perform a set of functions including termination of mobile-originated calls.

4. A rescue cellular access point, comprising: a self-contained cellular network with autonomous air interface and network control functions, a database of handset identities and a user interface, graphical or text-based, controlling that self-contained cellular network to perform a set of functions including placement of mobile-terminated calls without knowledge of assigned telephone numbers.

5. A rescue cellular access point, comprising: a self-contained cellular network with autonomous air interface and network control functions, a database of handset identities and a user interface, graphical or text-based, controlling that self-contained cellular network to perform a set of functions including handset location queries.

6. A rescue cellular access point, comprising: a self-contained cellular network with autonomous air interface and network control functions, a database of handset identities and a user interface, graphical or text-based, controlling that self-contained cellular network to perform a set of functions including control of the handset trans-mitter so that the handset can be used as a radio beacon to facilitate the location of the handset with radio direction finding equipment.

7. A rescue cellular access point, comprising: a self-contained cellular network with autonomous air interface and network control functions, a database of handset identities and a user interface, graphical or text-based, controlling that self-contained cellular network to perform a set of functions including the inducement of cellular handsets to generate audible ringtones to facilitate location of those handsets, without knowledge of assigned telephone numbers.

8. A rescue cellular access point, comprising: a self-contained cellular network with autonomous air interface and network control functions, a database of handset identities and a user interface, graphical or text-based, that uses cellular radio signal delay information and radio signal path loss information to together to determine the amount of debris obscuring the path between the handset and the rescue cellular access point.

9. A rescue cellular access point, comprising: a self-contained cellular network with autonomous air interface and network control functions, a database of handset identities and a user interface, graphical or text-based, that is permanently installed in an underground facility using a bidirectional radio repeater and leaky-coaxial cable antenna.

10. A rescue cellular access point, comprising: a self-contained cellular network with autonomous air interface and network control functions, a database of handset identities and a user interface, graphical or text-based, that is operated in an underground facility using a bidirectional radio repeater and leaky-coaxial cable antenna that uses radio path delays to determine the distance along the leaky-coaxial cable antenna from the rescue cellular access point to the handset.

11. A rescue cellular access point, comprising: a self-contained cellular network with autonomous air interface and network control functions, a database of handset identities and a user interface, graphical or text-based, that is operated in an underground facility using a bidirectional radio repeater and leaky-coaxial cable antenna that uses cellular radio signal delay information and radio signal path loss information to together to determine the amount of debris obscuring the path between the handset and the rescue cellular access point.
